(19) United States
(12) Patent Application Publication
(10) Pub. No.: US 2009/0319608 A1
(43) Pub. Date: Dec. 24, 2009

(54) AUTOMATED TASK CENTERED COLLABORATION

(75) Inventors: Robin Anil, Bangalore (IN); Mohit Gupta, Noida (IN); Joseph M. Joy, Bangalore (IN); Krishna Kumar Mehra, Bangalore (IN); Gopal R. Srinivasa, Bangalore (IN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/143,891

(22) Filed: Jun. 23, 2008

(51) Int. Cl. G06F 15/16; G06F 17/30

(52) U.S. Cl. 709/204; 707/100; 707/E17.044

(57) ABSTRACT

An automated task centered collaboration technique is described that significantly lowers the technological entry barrier for the development and deployment of a broad class of collaborative applications, which are termed Task Centered Collaboration (TCC) applications. TCC applications facilitate the processing of a large number of work items, or tasks, by people working independently or in small, synchronously collaborating groups. The technique also provides a mechanism for the study of computer mediated communication and human-computer interactions for this class of applications. The technique creates an abstraction applicable to the broad class of TCC applications, which enables the factoring out of significant portions of the application into a common infrastructure. It provides a programming model that enables a developer to focus on the User Interface and logic associated with operations on a single task, without being exposed to issues such as security, authentication, binding users to activities, synchronization, concurrency and persisting data.

### BACKGROUND

The Internet has enabled a class of applications where people collaborate towards completing tasks, having a variety of motivations to participate and without necessarily knowing each other. For example, the Distributed Proofreaders (DP) project enables volunteers to sign up to help with correction, formatting and proofreading tasks associated with getting books online as part of Project Gutenberg. Some applications go beyond farming out pieces of work to individuals working independently, leveraging instead the interactions among people. For example, one two-person synchronous image tagging game exists that cleverly leverages competitiveness to both motivate people to contribute, as well as to help cross-verify contributions. Sometimes, the motivation for the Internet community to participate can be monetary. This is part of the business plans of several companies. However, sometimes, users work towards a common cause without payment.

By leveraging interactions, the Internet becomes a source of collective, cross-validated wisdom that can be tapped to create, transform, and annotate digital information.

Today, an individual without significant engineering resources has limited options to tap into the pool of human resources, either within an organization or across the Internet. One can build a distributed application or service, but it takes significant engineering resources to build and deploy such applications due to the need for user management, data management, dealing with data concurrency and messaging, application health monitoring and other reasons. This is in stark contrast to standalone applications. For example, script-driven desktop applications, high-level languages and frameworks have empowered people from a broad range of disciplines, including those from non-Information Technology (IT) disciplines, to either build a standalone collaborative application from scratch or to customize existing applications for specific needs.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The automated task centered collaboration technique described herein significantly lowers the technological entry barrier for the development and deployment of a broad class of collaborative applications, which are termed Task Centered Collaboration applications herein. Task Centered Collaboration (TCC) applications facilitate the processing of a large number of work items, or tasks, by people working independently or in small, synchronously collaborating groups. The technique also provides a mechanism for the study of computer mediated communication and human-computer interactions for this class of applications.

In one embodiment, the technique creates an abstraction (a model of a task centered collaboration system), applicable to the broad class of TCC applications, which enables the factoring out of significant portions of the application into a common infrastructure. It provides a programming model that enables a developer to focus on the User Interface (UI) and logic associated with operations on a single task, without being exposed to issues such as security, authentication, binding users to activities, synchronization, concurrency, and persisting data. In one embodiment, the model includes a serialized, typed message passing model to facilitate synchronous collaboration when working on a task.

In the following description of embodiments of the disclosure, reference is made to the accompanying drawings which form a part hereof, and in which are shown, by way of illustration, specific embodiments in which the technique may be practiced. It is understood that other embodiments may be utilized and structural changes may be made without departing from the scope of the disclosure.

### DESCRIPTION OF THE DRAWINGS

The specific features, aspects, and advantages of the disclosure will become better understood with regard to the following description, appended claims, and accompanying drawings where:

FIG. 1 provides a logical model of one exemplary embodiment of the automated task centered collaboration technique described herein.

FIG. 2 provides a schematic of the life cycle of a task for one embodiment of the automated task centered collaboration technique.

FIG. 3 provides a schematic of a room which matches actors and tasks employed in one exemplary embodiment of the automated task centered collaboration technique.

FIG. 4 provides a schematic of a dynamic room instantiation employed in one exemplary embodiment of the automated task centered collaboration technique.

FIG. 5 is a flow diagram depicting creating and using a task centered collaboration application by employing one exemplary embodiment of the automated task centered collaboration technique.

FIG. 6 is a diagram depicting one exemplary architecture in which one embodiment of the automated task centered collaboration technique can be practiced.

FIG. 7 provides a schematic of a logic server employed in one exemplary embodiment of the automated task centered collaboration technique.

FIG. 8 is an exemplary flow diagram depicting a process of creating and using a task centered application by employing one embodiment of the automated task centered collaboration technique.

FIG. 9 is another exemplary flow diagram depicting the creation of a task centered collaboration application and its use by employing one embodiment of the task centered collaboration technique.

FIG. 10 is an exemplary flow diagram depicting actors' actions in completing tasks in one embodiment of the automated task centered collaboration technique.

FIG. 11 is an exemplary flow diagram depicting a process of queuing tasks and actors' actions in completing tasks in one exemplary embodiment of the automated task centered collaboration technique.

FIG. 12 is a schematic of an exemplary computing device in which the automated task centered collaboration technique can be practiced.

### DETAILED DESCRIPTION

In the following description of the automated task centered collaboration technique, reference is made to the accompanying drawings, which form a part thereof, and which is shown by way of illustration examples by which the automated task centered collaboration technique described herein may be practiced. It is to be understood that other embodiments may be utilized and structural changes may be made without departing from the scope of the claimed subject matter.

### 1.0 Automated Task Centered Collaboration Technique

The following sections provide a description of task centered collaboration in general, an overview of the automated task centered collaboration technique, an exemplary architecture wherein the technique can be practiced, exemplary processes employing the technique and details of various implementations of the technique.

### 1.1 Overview/Background of Task Centered Collaboration (TCC)

Task Centered Collaboration (TCC) applications facilitate the processing of a large number of work items, or Tasks, by people working independently or in small, synchronously collaborating groups. A unifying characteristic of the class of collaborative applications is that collaboration revolves around independent chunks of data that are operated upon by the users of these applications. During the course of one or more user interactions, the data chunks are transformed or annotated with additional data. A data chunk that changes state and accumulates content is called a Task. Note that this definition of Task is focused on the data, not the user interaction activities that may operate on it. Synchronous collaboration often occurs by small sets of people on small, data-driven shared tasks. This includes one- and two-person games with data collection intent. Tasks can be operated on in multiple stages, and involve some amount of workflow, such as, for example, distributed proofreading, or where two users synchronously collaborate to annotate sections of an image, based on tags earlier submitted in a game.

Building TCC applications is not easy. This is due to the inherent need to synchronize the modifications to shared data by multiple people with varying roles, capabilities and trust levels.

One can lower the barrier to the development and deployment of TCC applications by sufficiently constraining the problem and this is effectively done in a number of cases. For example one TCC application enables non-technical users to create Human Intelligence Tasks (HITs) for some common scenarios such as editing documents or image tagging. However, adding the slightest sophistication to the interaction such as the marking-out parts of an image demands one to be adept with web technologies. Even lightweight applications on the Internet require components to be well engineered before they can be published—authentication, data storage, security, and monitoring being some of them. Using web application frameworks requires significant technical knowledge. When synchronous collaboration is involved (as in games), the situation becomes considerably more complex, as there is a need for communication and synchronization amongst the users working on the same Task. A developer needs to be well versed with distributed programming techniques. The dynamic mapping of specific Tasks and user interaction activities to users, given application-specific constraints, is also non-trivial. Scalability and robustness also need to be addressed, given that a large number of Tasks (especially if they involve lightweight interactions) can be in execution simultaneously.

Deploying task centered collaboration applications is non-trivial and there are significant operational and administrative overhead. For an application that works on an Internet scale, it may be necessary to interface with replicated databases and clusters of servers which requires specialized technical knowledge.

### 1.2 The Task Centered Collaboration Environment

Despite the varied interaction modalities of a user (or users) working on a specific task there are many commonalities in these applications that can be factored out into a single infrastructure, such as:

User authentication and management

Database management and access

Synchronization for multi-user collaborative tasks

Managing Task lifecycles

Monitoring and evaluation

Administration for managing Tasks and analyzing usage statistics.

Security and protection from malicious user behavior.

The goal of the automated task centered collaboration technique is to move beyond building a set of common libraries and sophisticated design guidelines (thereby leaving the application author to compose and deploy the application), and get to a world where the author's burden is greatly minimized, so that she can focus on the specifics of the application (which is primarily the details of how users interact with a Task in the context of specific User Interaction activities, as well as the ability to upload and download aggregate data). The technique composes an abstraction that encompasses the class of TCC applications.

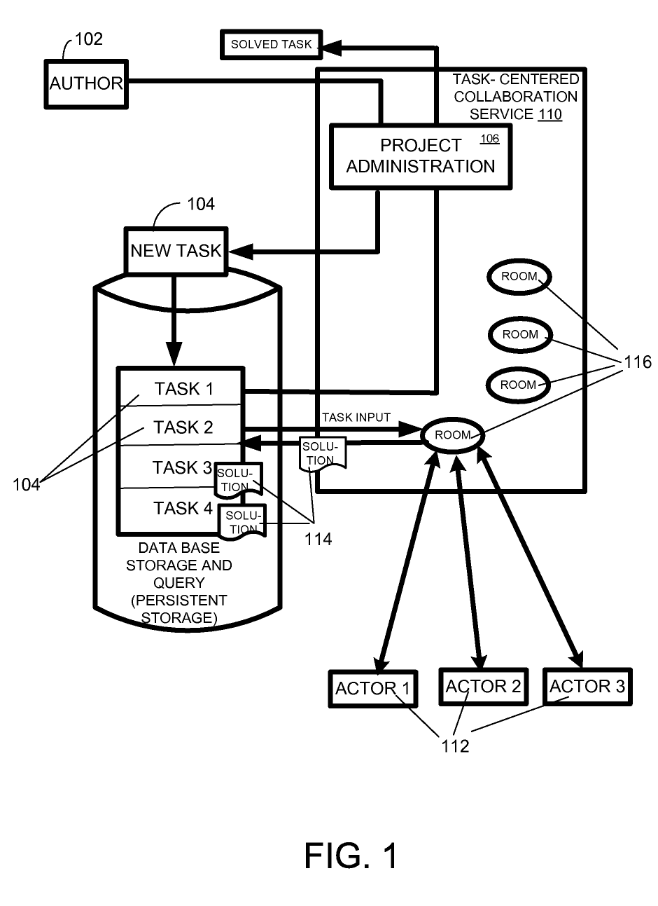

The task centered collaboration environment of one embodiment of the task centered collaboration technique is shown in FIG. 1. It provides a simple programming model to the application author that supports the full class of TCC applications. Concepts and components that are not specific to the particular application are factored out into a common infrastructure. The task centered collaboration environment provides a hosting environment for these applications. It also provides multiple points of extensibility. For example, the application author can have control over the user interface, and is able to run arbitrary “business intelligence” logic that can decide how to validate and incorporate the input from one or more parties contributing to a task to generate valid task result data. The environment also provides persistent storage for accumulated Task data. Persisted data is query-able by the business logic and supports complex task work flows. The task centered collaboration environment ensures that the choice of platform for the end-client interaction component is not constrained by the framework. Common platforms can include desktop applications, web browsers and popular social networking platforms. The task centered collaboration environment also supports an evaluation framework that authors can tap into to introspect on the running of the application.

The task centered collaboration environment implements the automated task centered collaboration technique's abstraction, which is the model of the system presented to the application author (Author). The core entities in the abstraction are presented in Table 1.

TABLE 1
Nomenclature

| | |
|---|---|
| Author | A person or organization that builds and deploys a task centered |
| | collaboration application. |
| Actor | A user who interacts with a Task. |
| Task | Data representing a unit of work, composed of Task Input, Task Constraints |
| | and a list of submitted Solutions |
| Task Input | Initial Task data submitted by the Author |
| Activity | Code that enables a specific kind of interaction between actors and tasks. |
| | Contains Logic and the User Interaction components. |
| Solution | Data appended to a Task by one or more Actors participating in an Activity. |
| Constraints | Metadata used to match Tasks, Actors and Activities |
| Project | Top level container used for establishing scope. Contains Activities, and |
| | Tasks |
| Room | A nexus of collaboration, consisting of an Activity, a Task list and an Actor |
| | list. |

The relationships among the entities are illustrated in FIG. 1 which depicts a logical model (the implementation can run on multiple machines). The Author 102 models the work that needs to be done as a set of Tasks 104, which is uploaded using an Author administration interface 106 into persistent storage maintained by the environment. Each distinct type of user interaction is called an Activity. A Task Centered Collaboration Service 110 contains the runtime state of the system. Actors 112 work (or more generally, interact) with Tasks 104, appending Solutions 114 to the tasks they work on. To facilitate this, the environment dynamically spawns a task centered collaboration abstraction called a Room 116. At any point the Actors 112 in a Room 116 interact with a single Task 104. The Room 116 is a fundamental abstraction, as it enables a simple programming model for collaboration on a particular Activity by a set of Actors 112 on a set of tasks 114. This is a unified model for single- and multi-user Activities.

Actors 112 in a Room 116 collaborate by exchanging messages with an Author provided, Activity-specific, Logic component that runs within the context of a Room. The Logic component may also maintain its own transient state. More details about the internal structure of a Room 104 are provided later in this section. Solutions 114 are persisted (appended to the Task record in the persistent database 108 maintained by the environment) as they complete. Tasks 104 can flow through multiple Activities, where each Activity represents a specific kind of interaction between a Task and one or more Actors. All solutions 114 are appended to the Task.

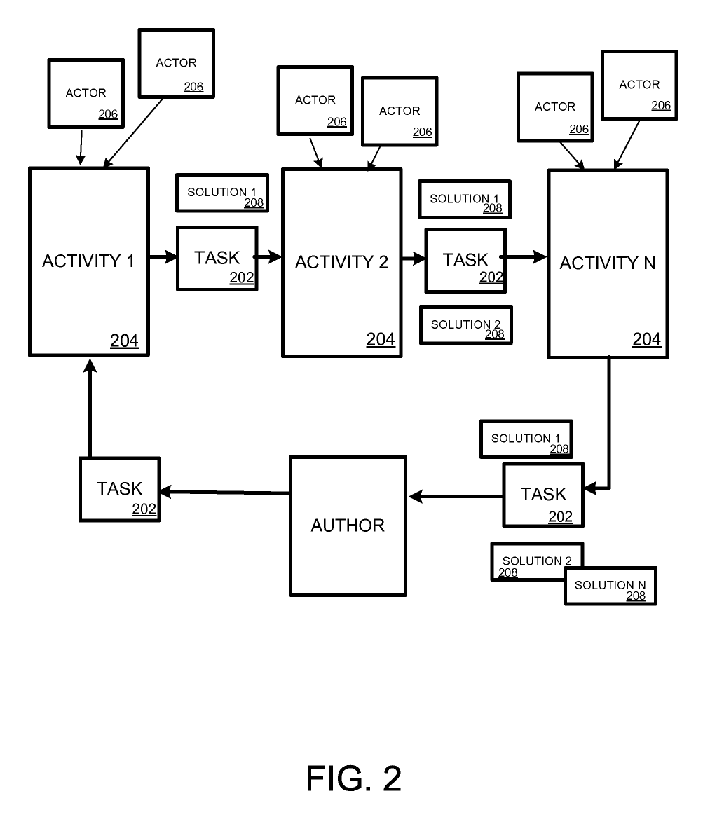

The flow of Tasks 202 through Activities 204 is explained in more detail in the next section entitled “Life Cycle of a Task”, which relates to FIG. 2. For example, using a video segmentation and annotation application as an example, the overall objective is to annotate and segment media clips. So in this example, each Task 202 represents a video or audio clip. For example, this annotation application has two Activities 204, an “annotate” activity and a “review” activity. In the annotate Activity, two or more Actors 206 collaborate synchronously, using the message dispatch facilities in a room, to create annotations. These annotations are accumulated as Solutions 208. The review Activity 204 enables an Actor 206 to approve the quality of a particular set of annotations. This decision is also appended to the Task 202 as a solution 208.

Tasks 202, Activities 204 and Actors 206 have a set of properties (name value pairs), and constraints on these properties. Constraints express compatibility requirements amongst Tasks 202, Actors 206 and Activities 204. A Room instantiator, described later, is responsible for dynamically matching up all the Actors 206, Tasks 202 and Activities 204 in a project, spawning a Room whenever there is a critical mass of compatible Actors and Tasks for a particular Activity.

To design an application using the task centered collaborative technique, the author needs to break it down into two components: a User Interaction (UI) component and a Logic Engine (LE) component. The Actors interact with the UI and their actions are encapsulated as messages and sent to the LE by messaging services provided by the task centered collaborative technique. Conversely, the LE can generate output messages, which are sent to the UI. All interactions are scoped by a particular Room.

### 1.3 Lifecycle of a Task

Conceptually, the life cycle of a Task is similar to that of an assembly line as illustrated in FIG. 2. Once created, a Task 202 is placed on the assembly line that circulates it through various stages defined for working on it. Each stage constitutes an Activity 204 that is performed on the Task 202 by one or more Actors 206, who add solutions 208 to it. These solutions 208 are also added to the state of the Task 202 and can be accessed during the subsequent stages. In any particular stage, the Task 202 is the combination of the original Task 202, and the solutions 208 added to it by the activities preceding the current Activity. More formally, Tₙ, the state of Task T at the start of the n^{th} stage to have operated on T, is given by the recurrence:

Tₙ=Tₙ₋₁U Sₙ₋₁

T₀={I, C}

where I is the Task Input, C is the Task constraints, and Sₖ is a solution added to the Task in stage k. For example, referring back to the previously mentioned video segmentation and annotation example, the state of the Task in the “review” Activity, consists of the video clip and the annotations added in a preceding “annotate” Activity. Authors can access Tasks and Solutions at any stage in the activity chain, and introduce new activities and tasks dynamically.

### 1.4 Rooms

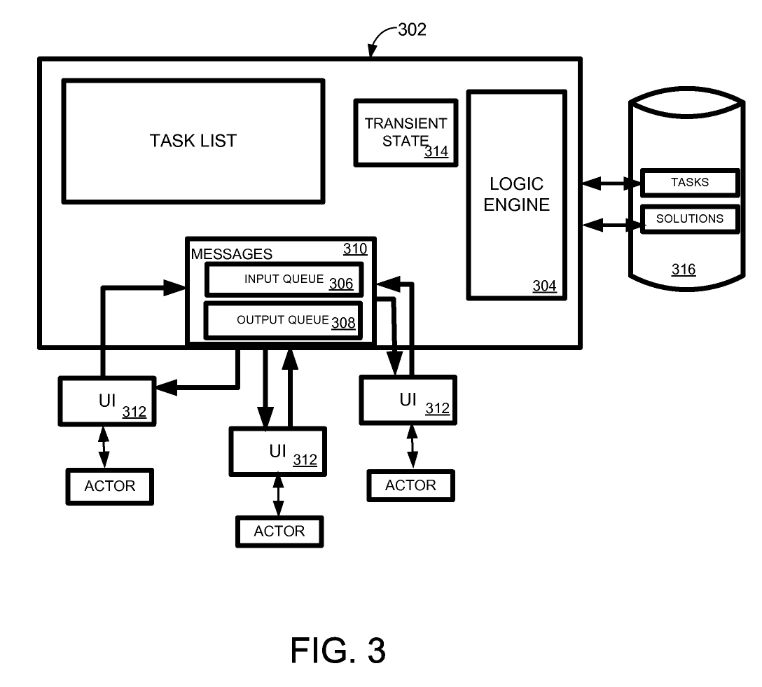

In one embodiment of the automated task centered collaboration technique, a Room scopes interactions concerning a specific set of Actors bound to an Activity and working on a set of Tasks. The mechanism for room instantiation is described later. FIG. 3 shows the conceptual structure of a Room 302.

The “active” part of the Room 302 is the logic engine 304, which is invoked periodically by a Logic Server, which will be discussed in greater detail later. Each Room 302 has an input 306 and output 308 message queue 310 that facilitate message passing between the user interaction component 312 and the logic engine component 304. Current program state (for instance, variables used by the code running in the logic engine) is stored in the Room 304 as a Transient state 314 which is isolated from other Rooms 302 of the same Activity. Completed tasks and solutions are stored in a database 316.

Rooms interact with the task centered collaborative technique environment through a set of status codes which are used to drive a finite state machine. This interaction model is described in more detail in the next section.

The task centered collaboration environment manages the transmission of messages, and thus any authored code does not have to concern itself with binding and transport mechanisms. Many rooms can be in execution simultaneously and each of them is provided a completely isolated environment. The system manages all of these Rooms, their states and the queues for messages. The system infrastructure is also responsible for a scalable implementation and all this happens in a concurrent fashion, with thread and lock management being done by the system while the author has to write simple sequential code as will be described later. The model is identical for single- and multi-user activities and greatly simplifies the process of developing applications.

### 1.5 Dynamic Room Instantiation Based on Constraints

The Room instantiation mechanism is designed to enable flexible, constraint-based rules for matching up Actors, Activities and Tasks. A Room is instantiated for an Activity whenever there is a critical mass of mutually compatible Actors and Tasks for the Activity. Compatibility is computed from Activity constraints that can refer to fields within both Actor qualifications and Task state. For single user activities, Rooms are instantiated whenever a new Actor arrives and there are Tasks compatible with that Actor. Rooms for multi-user activities are instantiated after the minimum number of actors can be matched to a Task. Additional constraints can be added. For example, in the annotate Activity of the previously discussed example of a video segmentation and annotation application, Actors who share a common language can be paired up with specific kinds of video content, and a minimum number of Actors to actively work on a particular video can also be specified through appropriate Constraints.

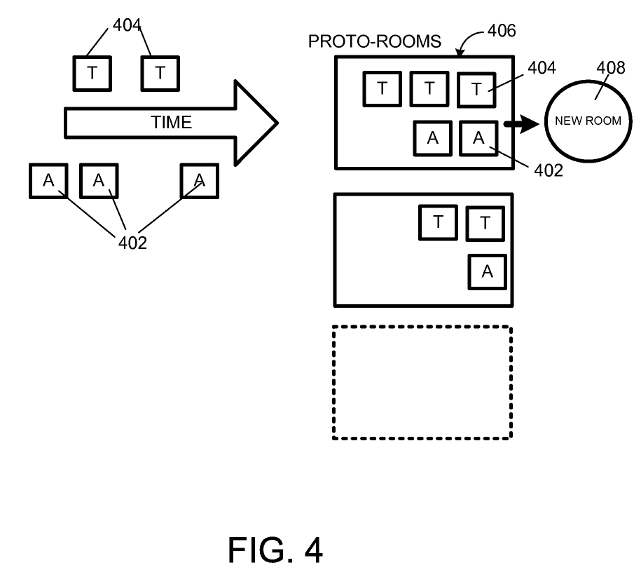

FIG. 4 illustrates how Rooms are instantiated, given an input stream of Actors 402 and Tasks 404. This mechanism is designed for responsive instantiation of Rooms given a constant influx of Actors and Tasks. The instantiator maintains a dynamic list of “Proto Rooms” 406, containing collections of compatible Tasks 404 and Actors 402 for a particular Activity. Each time an Actor A 402 becomes available for an Activity, or an Activity on a Task T 404 is completed, they are added to all the Proto Rooms 406 that they are compatible with. If no Proto Rooms 406 are available, a new one 406 is instantiated and an Actor A 402 or a Task T 404, is added to it. When there are enough Actors 402 and Tasks 404 in a Proto Room 406 to form a Room 408, a Room is instantiated (and the Actors 402 and Tasks 404 are removed from any other Proto Rooms 406 they had registered with).

### 1.6 Multistage Task Orchestration

Multi-stage Task orchestration is emergent behavior that stems from the way new Rooms are instantiated; one can control the Activities that successively work on a Task by setting up appropriate Activity constraints. This is best illustrated by an example. The constraint for the 2^{nd} (review) stage of the previously discussed example video annotation application is that the Task must have a solution added by the earlier annotate stage. This constraint-based, data-driven orchestration has been found to be flexible and simple to program.

### 1.7 Programming with the Automated Task Centered Collaboration Technique

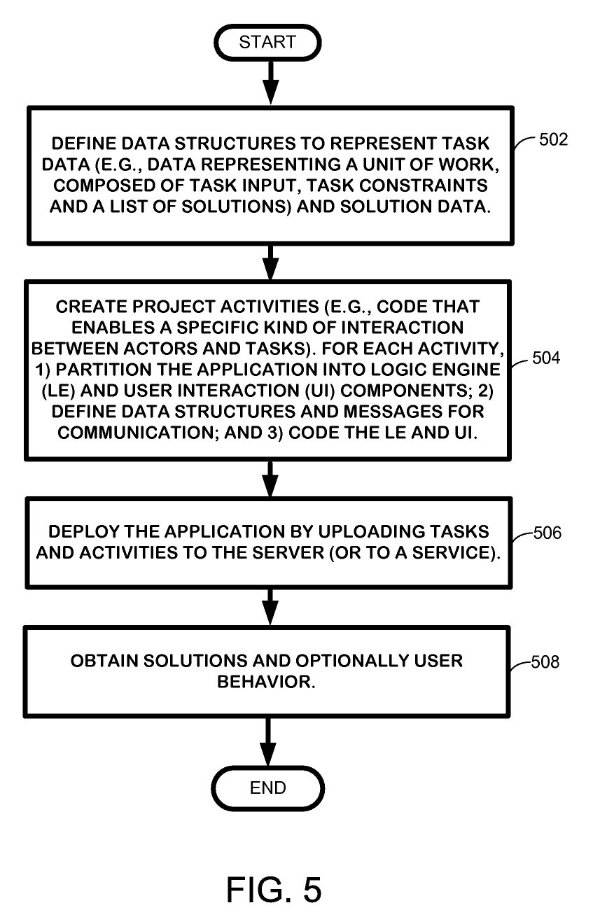

The automated task centered collaboration technique's programming model presented in this section focuses on core concepts and is simplified for the sake of clarity of exposition. As shown in FIG. 5, Authors follow this application development process:
1. Define data structures to represent the Task data, including solution data (box 502).
2. Create project activities (e.g., code that enables a specific kind of interaction between Actors and Tasks). For each Activity, as shown in box 504:
   a. Partition the application into Logic Engine (LE) and User Interaction(UI) components
   b. Define data structures and messages for communication
   c. Code the LE and the UI
3. Deploy the application by uploading Tasks and Activities to a server or service (box 506).
4. Receive solutions to the Tasks (and optionally user/Actor behavior on how Tasks were completed) (box 508).

The process actions of FIG. 5 will be discussed in greater detail in the following paragraphs.

### 1.7.1 Declaring Types/Defining Data Structures

As shown in FIG. 5, box 502, the first step in creating a task centered collaboration application is to define types/data structures used by the application. In one embodiment, these include data structures for Task Input, for Transient State, for the Solution, and for Messages. The data structures can be arbitrarily complex, with the only constraint being that they be serializable.

For example, in the video segmentation and annotation example previously discussed, the Task Input contains the URL for the video and the Solution for the annotate activity is a list of annotations for the video. The Transient State is the running list of annotations for the video. Messages for this example are of five types—three of them define the actions that can be performed on the annotations—creation, deletion, and modification, one of them indicates that the message is a chat message and one more is reserved for indicating that the task is complete.

### 1.7.2 Programming the Logic Engine

Referring to FIG. 5, box 504, in one embodiment of the technique, the Logic Engine (LE) code executes within the context of a Room, and is essentially a finite state machine which advances each time a message is received or optionally at periodic intervals. Messages from the UI are delivered to the LE via the Room, and the LE can update its state and communicate back with messages to the UI. During each invocation of the LE, the task centered collaboration environment passes to it a Context object that contains the input and output queues of the Room, and the transient state of the Activity. The LE can read the input queue, interpret the messages and take actions based on the messages received. An exemplary sequence is shown in pseudo code in Table 2. The LE may also send messages back to the user interaction component, update the transient state, check the quality of solutions, and add solutions to the persistent store.

Messages between UI and LE include both event-handling messages that request some action from the logic engine (for instance, a SkipCurrentTaskMessage), and data messages (like a SolutionAddedMessage).

In one embodiment of the automated task centered collaboration technique, the LE communicates with the task centered collaboration environment by returning status codes that drive a state machine, which has four states: INIT, RUNNING, COMPLETED and ERROR. In the INIT state, the task list of the Room is populated and a current task selected, and then the state is set to RUNNING. After this, the LE controls the state of the Room it is running in. This is done by returning one of the appropriate symbols: RUNNING, COMPLETED, or ERROR after each invocation.

TABLE 2
Pseudo-code for a Logic Engine

```
Procedure ExecuteLogicEngine
Input: Context c
Output: GameRoomStatusSymbol
begin
    state = c.getTransientState( )
    messages = c.getInputMessages( )
    outputs = new list
    statusSymbol = RUNNING;
    ...
    <modify state and populate outputs>
    ...
    c.enqueueMessagesforUsers(outputs);
    c.updateTransientState(state);
    return statusSymbol;
end
```

### 1.7.3 Programming the User Interaction

Referring back to FIG. 5, box 504, the User Interaction component interacts with the Logic Engine through messages, and is closely tied to the Logic Engine in terms of the messages it consumes and generates. The component itself can be embedded in any environment that can exchange messages with the task centered collaboration services, for example, in a website, mobile client or desktop application.

TABLE 3
Psuedo code for the user interaction component

```
Procedure SetupUI
begin
    registerUserForActivity(activity);
    <wait till game room started>
    info = getRoomInfo( );
    <setup UI and show the task>
end
Procedure ProcessUserInput
begin
    <interpret User input and create msg>
    sendMessageToLogicEngine(msg);
    r = retrieveResponseFromLogicEngine( );
    <process response and update UI>
begin
```

The pseudo-code for a typical UI component is given in Table 3. In one embodiment of the technique, at a high level, the user interaction component consists of two steps: First, it sets up the user interface for the Actor to work on the task data. This involves registering the actor, waiting for the Actor to be assigned to a Room, and the actual setup of the user interface using information retrieved from the Room. The information obtained includes task data, other actors in the room, and metadata like task constraints, activity constraints and Actor qualifications. In the second step, the component responds to actor actions and sends messages (solutions, event handling messages) to the LE. Results from the LE (successful solution submission, or solutions failing validation checks) are retrieved as messages and appropriate actions taken.

For the previously discussed video segmentation and annotation example, first the UI is setup, and then the video starts playing when the room starts. User actions (add/modify/delete) are intercepted by the client and encapsulated into a message and sent to the LE. The UI is updated based on messages from the LE—e.g., in case of a chat message, it is shown in a chat box on a display, and the UI indicates completion on receiving a TaskComplete message.

### 1.7.4 Deploying and Administering the Application

As shown in FIG. 5, box 506, in one embodiment of the automated task centered collaboration technique, the application is deployed (e.g., by uploading it to the server) and tasks are added. The application can be compiled and the resulting library can be submitted to the task centered collaborative service for deployment. The administration interface can be used to add tasks to the project and retrieve solutions. For instance, in case of the video segmentation and annotation application example, the Author should submit URLs for each of the videos that are to be annotated. The user interface can be hosted on a web server (also provided by the task centered collaborative service) or distributed as desktop applications.

### 1.7.5 Obtaining the Solution

As shown in FIG. 5, box 508, in one embodiment of the technique, the solutions to the Tasks, and optionally information on user behavior in the completion of Tasks, can be accessed by retrieving them for a data base where they are stored.

### 1.7.6 Discussion

The task centered collaborative technique's programming model is designed to allow simplicity and extensibility while developing the applications. Application logic can be written as though a single instance of the application is running. Application state can therefore be stored as part of the logic, and can be accessed without the fear of race conditions. Programming the logic engine is therefore simpler. Since the author can plug-in her own data structures and custom logic, the system is very extensible, and a diverse group of activities can be developed.

Since the application logic runs in the same environment during both development and deployment, applications can be developed and tested completely on development machines before being deployed on hosting servers, without the fear of unexpected bugs caused by differing environments. Issues of scaling the application to large numbers of instances are now handled by the platform. Isolating parallel instances of an application, as well as instances of other applications from one another is also managed by the platform. Finally, security is tightened because the logic server can be configured to disallow certain Application Programming Interface (API) calls, by either loading the application logic in custom runtimes, or by configuring the runtime to disallow certain API calls. This prevents hacked applications from running amok.

### 1.8 Architecture, Design and Implementation

In this section, a more detailed description of the architecture of some of the components of one embodiment of a system employing the automated task centered collaboration technique. The system is designed with helper libraries and various services that interact with each other to provide functionalities to the user. In one working embodiment, the system is implemented in C# using the .NET platform and technologies such as Windows Communication Foundation and Language Integrated Query.

### 1.8.1 Architecture

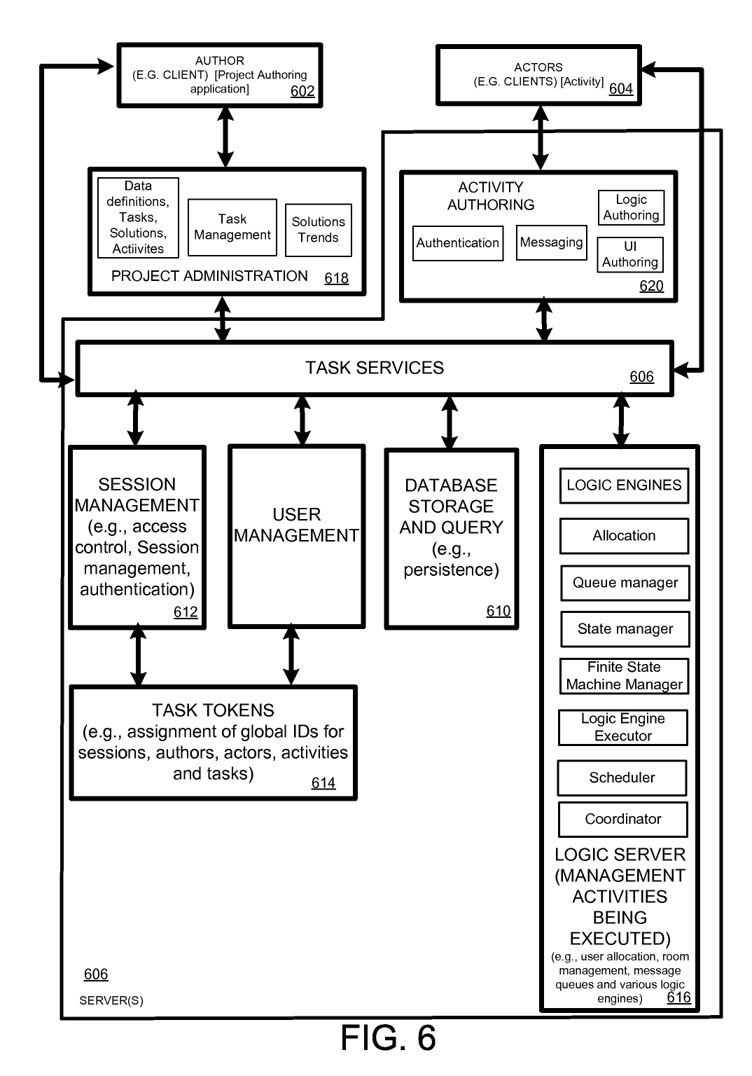

One exemplary architecture in which the automated task centered collaboration technique can be practiced is shown in FIG. 6. The Author 602 and the Actors 604 communicate to the task centered collaboration system 606 through the task centered collaboration service layer 608 which, in one embodiment, provides a single Facade design pattern for interacting with the system, where a single “Façade” composite API provides an integrated set of APIs to access various aspects, such as project management and activity authoring, of the system. The service can be accessed over multiple transports, such as, for example, HTTP web services and .NET Remoting. This ensures flexibility and more optimal utilization within the intranet. Both browser-based and desktop clients can connect to it. The architecture also includes an a project administration module 618 and an Activity authoring module 620 that allow an Author 602 to build a task centered collaboration application, as previously discussed.

The Persistence layer 610 abstracts database storage and query, and is used internally by all the layers above it, including the management of Author data. It also checks data for consistency before adding it to the database. The Session Management Service 612 is responsible for access control and unified session management for both desktop and browser-based applications. It supports multiple authentication mechanisms. The Author 602 can choose to allow anonymous access to certain Activities or even define custom authentication mechanisms. Timed sessions are assigned to users after authentication for a specific role (Author or different Actor roles). In one embodiment, all entities in the task centered collaboration environment (Sessions, Authors, Actors, Activities and Tasks) are allocated a Token 614, which encapsulates their globally-unique id. Tokens 614 contain discriminators for identifying the type of parent entity and are used at various levels to check for access privileges based on user role. Tokens 614 are also used for tracking relationships between entities, as part of a monitoring framework.

Once the session is created, the Logic Server 616 manages the actual activities being executed. For example, it manages user-allocation, Rooms, message queues and the scheduling of the various Logic Engines.

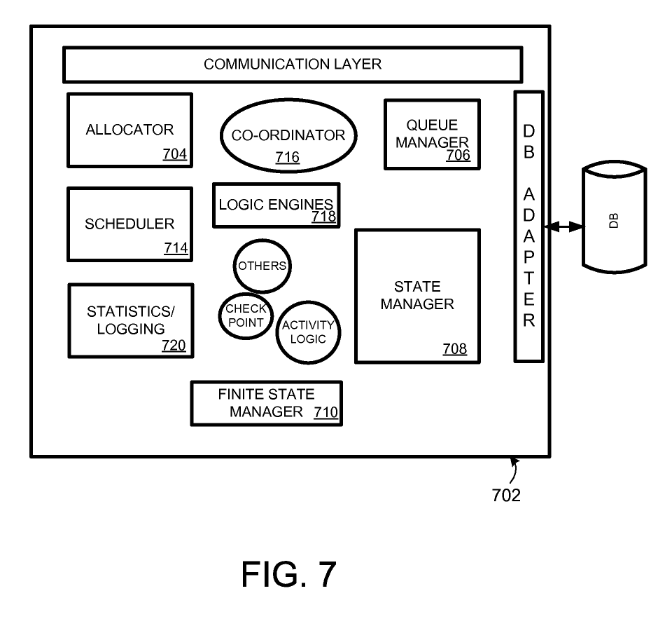

The various components of the Logic Server 702 are shown in FIG. 7 and are listed below:

Allocator (704): The Allocator 704 enables matching of Actors with Tasks, based on the constraints as was described with respect to dynamic room instantiation.

Queue Manager (706): The Queue Manager 706 maintains message queues for Actors and Rooms. Message queues for Actors get cleared when the Actor retrieves messages, and for rooms when the context is set up.

State Manager (708): The State Manager 708 behaves as a store that maintains the transient state of all the Activities in execution. When a room is created, the state is initialized to the default state provided by the Author, and thereon, the state is retrieved from the store and handed to the Logic Engine during execution and deposited back when execution completes.

Finite State Machine (FSM) Manager (710): The Logic Engine Executor 710 maintains the state of the rooms (e.g., Init, Running, Exit and Checkpoint) as a finite state machine. The FSM Manager 710 finds state transitions, and also schedules bookkeeping activities like cleanup, check-pointing and similar activities.

Logic Engine Executor (712): The Logic Engine Executor 712 executes the logic engines provided by the Authors. Before running the Activity Logic Engine (LE), the Logic Engine Executor 712 prepares a context populating it with the currently queued messages, the transient state, and information about the room. The Queue-Manager 706 and the State-Manager 708 need to maintain states for all the players under the protection of proper locks. The Logic Server 702 is designed to be highly concurrent and executes many LEs simultaneously in different threads.

The Scheduler (714): The Scheduler 714 manages the thread pools and queues up the Logic Engines to be executed as per the specified tick-time, and the availability of the worker threads.

The Coordinator (716): The Coordinator 716 ties all these modules together. Multi-threading and lock management complexity is hidden within this layer so that the Author of the application can write sequential code.

Statistics and Logging (720): A module for statistics and logging of task and user data can also be employed in the Logic Server.

The Author's program logic is run within the context of the task centered collaboration service and failure of Author's code does not affect the system. Since the operational semantics of the LE are restricted to message passing and does not need to store private transient state, static verification that the LE does not contain malicious code is viable.

### 1.9 Exemplary Processes for Employing the Automated Task Centered Collaboration Technique

The details of various embodiments of the technique having been discussed, the following section provides an overview of exemplary processes for employing the automated task centered collaboration technique.

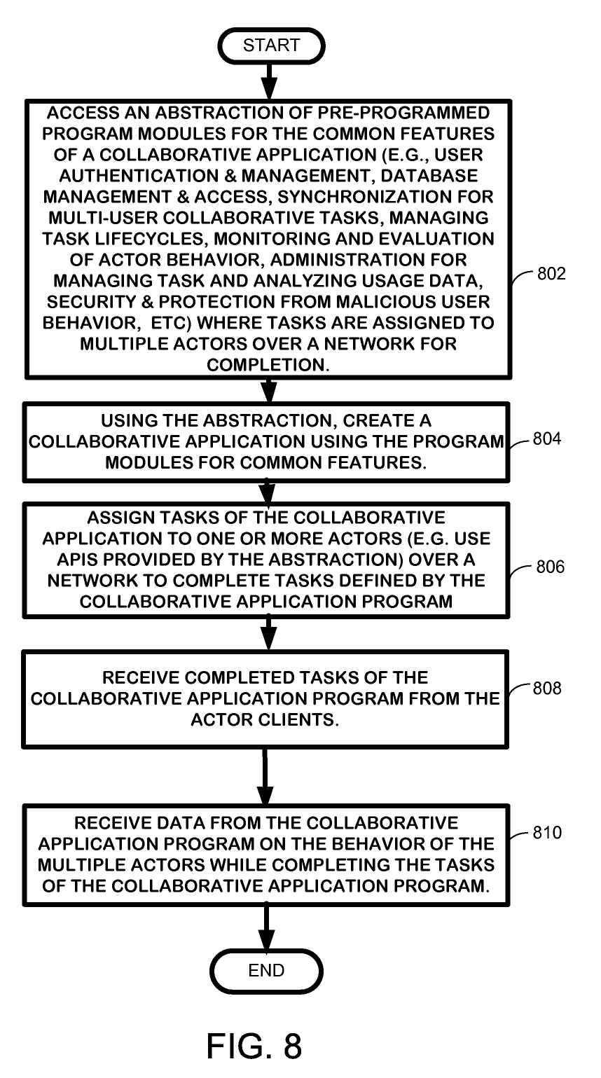

An exemplary process for creating and using a collaborative application in one exemplary embodiment of the automated task centered collaboration technique is shown in FIG. 8. As shown in FIG. 8, box 802, an abstraction of pre-programmed program modules for the common features of a collaborative application, where tasks are assigned to multiple actors over a network for completion, is accessed. For example, in one embodiment, these pre-programmed modules include user authentication and management, database management and access, synchronization for multi-user collaborative tasks, managing task lifecycles, monitoring and evaluation of actor behavior, administration for managing task and analyzing usage data, security and protection from malicious user behavior, and so on. Using the abstraction, a collaborative application is created using the program modules for the common features (box 804). The abstraction is then used to assign tasks of the collaborative application to one or more actors (e.g., clients) over a network to complete the task or tasks defined by the collaborative application program, as shown in box 806. The completed tasks of the collaborative application program (e.g., the solutions) are then received from the actor clients, as shown in box 808. Additionally, data from the collaborative application program on the behavior of the actors while completing the tasks of the collaborative application program, is optionally received (box 810).

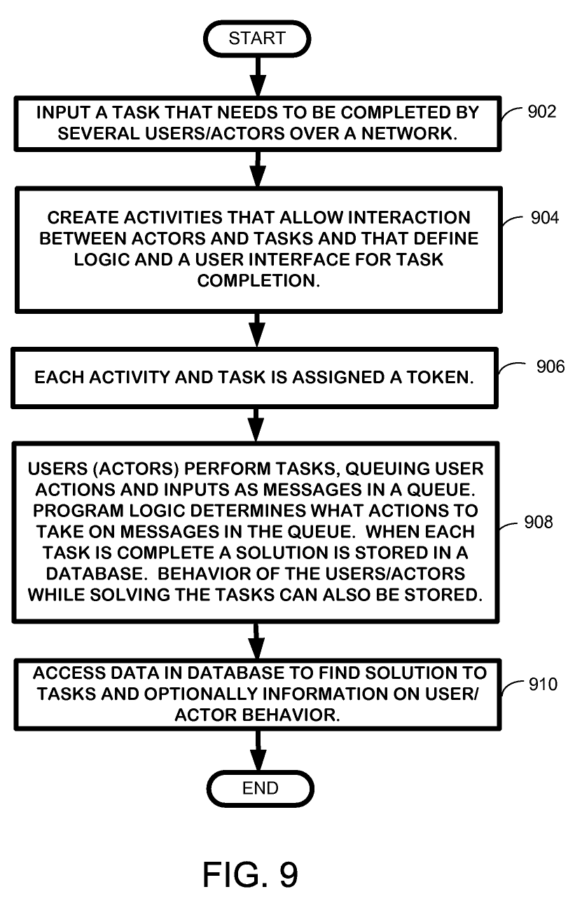

Another exemplary process for employing the automated task centered collaboration technique to create a collaborative application, assign tasks and receive solutions, is shown in FIG. 9. As shown in FIG. 9, box 902, a task or tasks that need to be completed by one or more actors/clients over a network is input. For each task, activities that allow interaction between an actor and a task and define program logic and a user interface for completing the task are defined (box 904). A unique token is assigned to the tasks and activities to classify them into a project (box 906). Users/actors perform tasks, queuing user actions and inputs as messages in a queue. The program logic determines what actions to take on the messages in the queue. When each task is complete a solution is stored in a database, and users/actor behavior while solving the tasks can also be stored (box 908). Data in the database is accessed to find solutions to the tasks and optionally to retrieve information on user/actor behavior while completing the tasks (box 910).

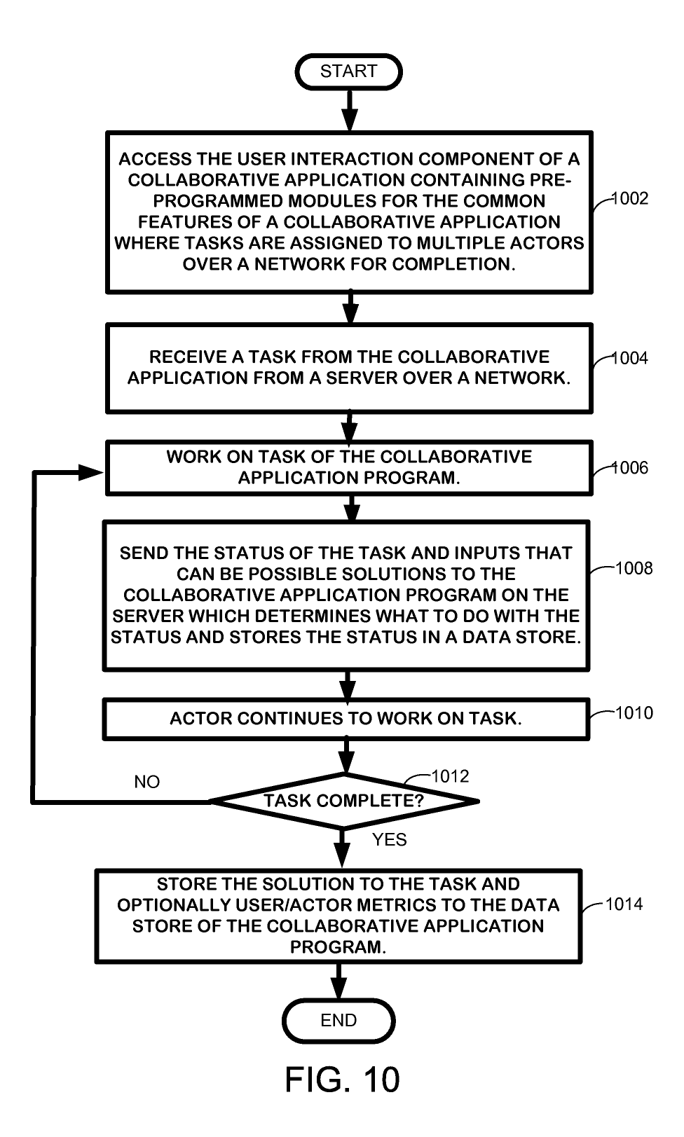

FIG. 10 shows another exemplary process for employing the automated task centered collaboration technique that depicts the actors' actions. As shown in box 1002, an actor accesses the user interaction component of a collaborative application containing pre-programmed modules for the common features of a collaborative application where tasks are assigned to multiple actors over a network for completion. The actor receives a task from the application from a server over a network, as shown in box 1004. The actor then works on the task (box 1006), and sends the status of the task to the collaborative application on the server which determines what to do with the status and stores the status in a database store (box 1008). The actor continues to work on the task, periodically providing task status to the collaborative application program (box 1010) until the collaborative application program determines the task is complete and stores the solution to the task, and optionally user/actor metrics, to the database store (boxes 1012, 1014).

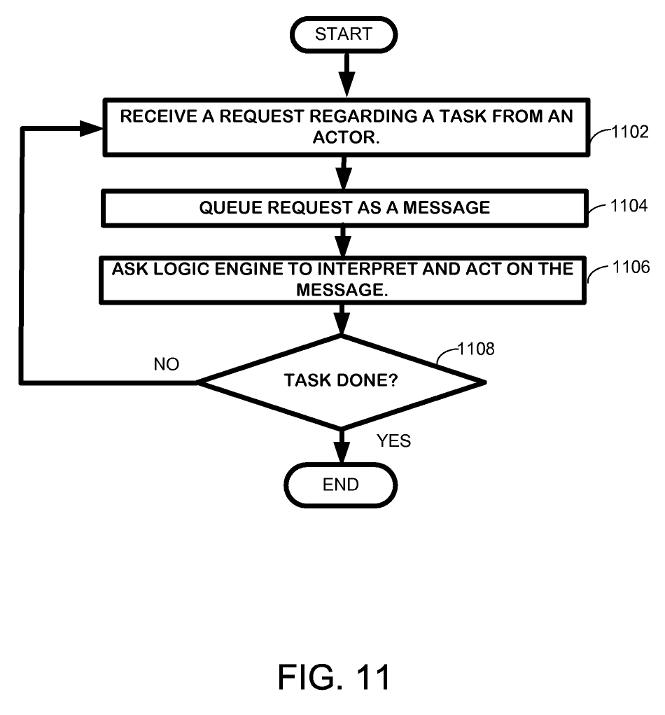

FIG. 11 shows another exemplary process for employing the automated task centered collaboration technique. In this flow chart queuing logic is depicted. As shown in box 1102, a request regarding a task is received from an actor. The request is queued as a message (box 1104) and a logic engine is called on to interpret and act on the message (box 1106). A check is made to see if the task processing is complete (box 1108). If so, another request is receive from an actor (box 1102). If the task processing is complete the process ends and if not another request is received from the actor (boxes 1108, 1102).

### 1.10 Alternate Embodiments

It should be noted that many alternative embodiments to the discussed embodiments are possible, and that steps and elements discussed herein may be changed, added, or eliminated, depending on the particular embodiment. These alternative embodiments include alternative steps and alternative elements that may be used, and structural changes that may be made, without departing from the scope of the disclosure. The following paragraphs provide some possible alternate embodiments of the automated task centered collaboration technique.

### 1.10.1 Disconnected Operations

In some scenarios, Actors may work off line on Activities. For example, an actor may log into the system, download some tasks for later work, disconnect the system, work on the tasks while offline from the system, and later connect to the system and upload the solutions for the tasks. In such cases, one embodiment of the automated task centered collaboration system sets a status of “reserved” for the downloaded tasks, so that they are not reassigned to other Actors while they are being worked on offline. This is particularly useful (but not restricted to) scenarios where the Actors are mobile, the UI is implemented on mobile devices, and the Actors may need to be disconnected from the network when performing the Activities.

### 1.10.2 Computing Resources Serving as Actors

In some scenarios, Actors can be computational resources, not humans. For example, an Actor can be a computational resource performing some computationally intensive task such as machine-learning based classification. In another example, an Actor can be a computational resource accessing data external to the automated task centered collaboration system. These kinds of external computational resources can be incorporated into a Task workflow without any modifications, by having them conform to an Actor protocol when interacting with the rest of the system.

### 1.10.3 Static Analysis of Author-Supplied Logic Engine Code

In some embodiments of the automated task centered collaboration technique, the author-supplied Logic Engine code must confirm to strict guidelines of servicing input messages, updating state, and optionally generating output messages. The code should not perform arbitrary or malicious operations that are not related to the bona fide interaction with Actors and updating solution state. These checks can be performed by a Static Analysis stage when accepting Author supplied logic into the system, by using existing Static Analysis techniques commonly applied in the computing world. Applying static analysis provides the dual benefit of providing feedback to the Authors if the Logic Engine has faulty behavior, as well as insulating the system from malicious or unintentional behavior.

### 2.0 The Computing Environment

The automated task centered collaboration technique is designed to operate in a computing environment. The following description is intended to provide a brief, general description of a suitable computing environment in which the automated task centered collaboration technique can be implemented. The technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

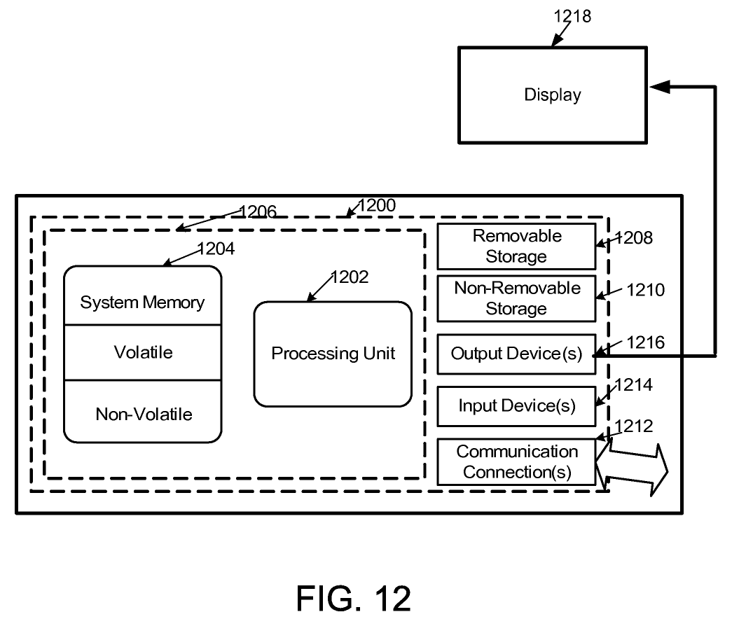

FIG. 12 illustrates an example of a suitable computing system environment. The computing system environment is only one example of a suitable computing environment and is not intended to suggest any limitation as to the scope of use or functionality of the present technique. Neither should the computing environment be interpreted as having any dependency or requirement relating to any one or combination of components illustrated in the exemplary operating environment. With reference to FIG. 12, an exemplary system for implementing the automated task centered collaboration technique includes a computing device, such as computing device 1200. In its most basic configuration, computing device 1200 typically includes at least one processing unit 1202 and memory 1204. Depending on the exact configuration and type of computing device, memory 1204 may be volatile (such as RAM), non-volatile (such as ROM, flash memory, etc.) or some combination of the two. This most basic configuration is illustrated in FIG. 12 by dashed line 1206. Additionally, device 1200 may also have additional features/functionality. For example, device 1200 may also include additional storage (removable and/or non-removable) including, but not limited to, magnetic or optical disks or tape. Such additional storage is illustrated in FIG. 12 by removable storage 1208 and non-removable storage 1210. Computer storage media includes volatile and nonvolatile, removable and non-removable media implemented in any method or technology for storage of information such as computer readable instructions, data structures, program modules or other data. Memory 1204, removable storage 1208 and non-removable storage 1210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 1200. Any such computer storage media may be part of device 1200.

Device 1200 may also contain communications connection(s) 1212 that allow the device to communicate with other devices. Communications connection(s) 1212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. The term computer readable media as used herein includes both storage media and communication media.

Device 1200 may have various input device(s) 1214 such as a display, a keyboard, mouse, pen, camera, touch input device, and so on. Output device(s) 1216 such as speakers, a printer, and so on may also be included. All of these devices are well known in the art and need not be discussed at length here.

The automated task centered collaboration technique may be described in the general context of computer-executable instructions, such as program modules, being executed by a computing device. Generally, program modules include routines, programs, objects, components, data structures, and so on, that perform particular tasks or implement particular abstract data types. The automated task centered collaboration technique may be practiced in distributed computing environments where tasks are performed by remote processing devices that are linked through a communications network. In a distributed computing environment, program modules may be located in both local and remote computer storage media including memory storage devices.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

Wherefore, what is claimed is:

1. A computer-implemented creating an application for assigning tasks of a project that can be distributed to a number of actors over a network for the actors to collaboratively complete the tasks, comprising:
for tasks of a project, defining data structures to represent task data and solution data;
creating project activities that enable interaction between actors and tasks; and
uploading the tasks and activities to a server for distribution to one or more actors to collaboratively determine solutions for the tasks.

2. The process of claim 1 wherein creating project activities and uploading tasks to a server, for each activity further comprises:
partitioning each activity into a logic engine and a user interaction component;
defining data structure and messages for communication for each activity;
programming a logic engine and user interface for each activity;

3. The computer-implemented process of claim 1 further comprising obtaining solutions to the tasks wherein each task is performed by the one or more actors in stages and wherein a solution to a task created in each stage is added to the task.

4. The computer-implemented process of claim 1 further comprising receiving information on actor behavior concerning actors' time-stamped interactions while performing activities.

5. The computer-implemented process of claim 1 wherein the task data further comprises a unit of work comprising a task input, task constraints and a list of solutions.

6. The computer-implemented process of claim 2 wherein the logic engine is a finite state device that advances each time a message is received or at periodic intervals.

7. The computer-implemented process of claim 2 wherein the logic engine executes within the context of a room that comprises at least one activity, a task list and an actor list.

8. The computer-implemented process of claim 5 wherein the tasks constraints are metadata used to match actors, tasks and activities.

9. The computer-implemented process of claim 1 wherein solution data is data appended to a task by the one or more actors participating in an activity.

10. A computer-implemented process for creating and using a collaborative application, comprising:
accessing an abstraction of pre-programmed program modules for common features of a collaborative application where tasks are assigned to one or more actor clients over a network for completion;
using the abstraction, creating a collaborative application using the pre-programmed program modules for the common features;
assigning tasks of the collaborative application to the one or more actors over a network to complete tasks defined by the collaborative application program; and
receiving completed tasks of the collaborative application program from the one or more actor clients.

11. The computer-implemented process of claim 10, further comprising:
receiving data from the collaborative application program on the behavior of the one or more actor clients while completing the tasks of the collaborative application program.

12. The computer-implemented process of claim 10 wherein the pre-programmed program modules for the common features of a collaborative application, further comprise modules for performing at least one of the group of:
user authentication and management;
data base management and access;
synchronization for multi-user collaborative tasks;
management of task life cycles;
security and protection from malicious entities; and
administration for managing tasks.

13. The computer-implemented process of claim 11 wherein the pre-programmed program modules for the common features of a collaborative application, further comprise modules for performing:
analysis of usage data; and
monitoring and evaluation of actor behavior.

14. The computer-implemented process of claim 10 wherein creating a collaborative application using the pre-programmed program modules for common features, further comprises:
inputting each task that needs to be completed by the one or more actors over a network;
for each task, creating activities that allow interaction between a task and an actor and that define program logic and a user interface for completion of the task;
assigning a unique token to classify the tasks and activities into a project;
receiving from the one or more client actors messages regarding the tasks and queuing the messages in a queue;
using the program logic to determine what actions to take on messages in the queue;
when each task is complete, storing a task solution for each task in a database; and
accessing the task solution for each task in the database in order to determine the task solution for the task.

15. A system for creating a collaborative application for distributed computing, comprising:
a general purpose computing device;
a computer program comprising program modules executable by the general purpose computing device, wherein the computing device is directed by the program modules of the computer program to,
author a collaborative project where project tasks are created by an author by accessing a project authoring application containing pre-programmed program modules for the common features of a collaborative application where tasks are assigned to multiple actors;
assign tasks of the collaborative project to the multiple actors to complete tasks using a task services module;
manage the completion of tasks using the task services module and a logic server;
store solutions to completed tasks in a database; and
receive completed tasks from the multiple actors by accessing solutions to the tasks stored in a database.

16. The system of claim 15 wherein the logic server, further comprises:
logic engines;
a logic engine executor that executes the logic engines provided by the authors;
a queue-manager that manages the execution of messages received from the multiple actors;
a state-manager that maintains states for tasks, activities, actors;
a scheduler that schedules the execution of tasks;
a coordinator that coordinates the logic engine executor, the queue manager, the state-manager and the scheduler.

17. The system of claim 15 wherein an actor can be a computational resource performing a computationally intensive task or accessing external data.

18. The system of claim 15 wherein actors can download one or more tasks to work on when offline, and subsequently connect and upload completed tasks.

19. The system of claim 15 wherein static analysis is performed on activity-related code provided by authors to validate proper functioning of the code and disallow malicious or inappropriate functionality in the code.

20. The system of claim 15 where multiple activities are orchestrated on a task by specification of suitable task constraints for each activity.
